(19) United States
(12) Patent Application Publication
(10) Pub. No.: US 2018/0257262 A1
(43) Pub. Date: Sep. 13, 2018

(54) PROPYLENE-BASED RESIN-ADHERED FIBER BUNDLE

(71) Applicant: DAICEL POLYMER LTD., Minato-ku, Tokyo (JP)

(72) Inventor: Masahiro KATAYAMA, Himeji-shi, Hyogo (JP)

(21) Appl. No.: 15/760,439

(22) PCT Filed: Sep. 13, 2016
(86) PCT No.: PCT/JP2016/076922

§ 371 Date: Mar. 15, 2018

(30) Foreign Application Priority Data
Sep. 30, 2015 (JP) 2015-193032

(51) Int. Cl. B29B 9/06; B29B 9/14; B29B 15/12; C08L 23/14

(52) U.S. Cl. CPC B29B 9/06; B29B 9/14; B29K 2023/12; C08L 23/14; B29B 15/12

(57) ABSTRACT

[Problem]

To provide a propylene-based resin-adhered fiber bundle having an enhanced binding force between a carbon long fiber bundle and a propylene-based resin by associating a carbon fiber concentration and a fiber bundle diameter with each other.

[Means for solution]

A propylene-based resin-adhered carbon fiber bundle prepared by cutting a carbon fiber bundle integrated with a propylene-based resin adhered thereto, wherein: the propylene-based resin contains a base polymer selected from a propylene homopolymer and a propylene copolymer, and an acid group-containing propylene-based resin and/or an amino group-containing propylene-based resin; the carbon fiber bundle has a sizing agent adhered on a surface thereof; and an outer diameter is 2.8 to 4.2 mm, a carbon fiber concentration is 5 to 25 mass % and a length is 4 to 50 mm.

### TECHNICAL FIELD

The present invention relates to a propylene-based resin-adhered fiber bundle, a method for manufacturing the same, and a molded article obtained from the fiber bundle.

### BACKGROUND ART

JP-B 4354776, JP-B 5021066 and JP-A 2007-112041 disclose inventions, which include a carbon long fiber-reinforced resin pellet utilizing a propylene resin and a carbon long fiber bundle.

JP-B 4354776 discloses an invention of a molded article obtained from a carbon long fiber-reinforced resin pellet, which is composed of a carbon fiber surface-treated with an epoxy sizing agent having an epoxy group and a maleic acid-modified polypropylene. It describes that a thermal reaction between an epoxy group of the sizing agent and maleic acid provides a molded article with a good mechanical strength (paragraph 0016). In Examples (Tables 1 and 2) thereof, examples having carbon fiber concentrations of 30% and 40%, respectively, are described.

The invention of JP-B 5021066 is a method for manufacturing a carbon long fiber-reinforced resin pellet, which utilizes a carbon fiber surface-treated with an epoxy sizing agent having an epoxy group and a maleic acid-modified polypropylene, wherein after the carbon long fiber-reinforced resin pellet is manufactured, heating treatment is performed under a specific heating treatment condition. It describes that heating treatment under the specific condition provides a molded article with a good mechanical property (paragraphs 0007 and 0025).

JP-A 2007-112041 discloses an invention of a molded article of carbon long fiber-reinforced resin, which is injection-molded from a carbon long fiber-reinforced resin pellet prepared by surface-treating a carbon fiber with a sizing agent (s) having a functional group capable of reacting with an acid group, and impregnating the carbon fiber with an acid group-containing polyolefin-based resin (A), wherein a cylinder of an injection molding machine has a temperature of 250 to 300° C. during injection molding. It describes that the mechanical property of a molded article is enhanced by setting the temperature of the cylinder of the injection molding machine in the range of 250 to 300° C. during injection molding (paragraph 0025). In Examples of Table 1, for example, Example 1 (carbon fiber concentration of 40 mass %) and Example 8 (carbon fiber concentration of 20 mass %), the Example having a higher carbon fiber concentration exhibits a higher mechanical strength when other conditions are the same.

### SUMMARY OF INVENTION

The present invention has an object of providing a propylene-based resin-adhered fiber bundle, a method for manufacturing the same and a molded article obtained from the fiber bundle, wherein a binding force between a carbon long fiber bundle and a propylene-based resin is enhanced by associating a carbon fiber concentration and a fiber bundle diameter with each other.

The present invention provides a propylene-based resin-adhered carbon fiber bundle prepared by cutting a carbon fiber bundle integrated with a propylene-based resin adhered thereto, wherein:

the propylene-based resin contains a base polymer selected from a propylene homopolymer and a propylene copolymer, and an acid group-containing propylene-based resin and/or an amino group-containing propylene-based resin;

the carbon fiber bundle has a sizing agent adhered on a surface thereof; and

the carbon fiber bundle has an outer diameter of 2.8 to 4.2 mm, a carbon fiber concentration of 5 to 25 mass % and a length of 4 to 50 mm, and

a manufacturing method thereof.

Further, the present invention provides a propylene-based resin-adhered carbon fiber bundle prepared by cutting a carbon fiber bundle integrated with a propylene-based resin adhered thereto, wherein:

the propylene-based resin contains a base polymer selected from a propylene homopolymer and a propylene copolymer, and an acid group-containing propylene-based resin and/or an amino group-containing propylene-based resin;

the carbon fiber bundle has a sizing agent adhered on a surface thereof; and

(a) when the propylene-based resin-adhered carbon fiber bundle has 20000 to 28000 carbon fibers, it has an outer diameter of 3.3 to 4.2 mm, a carbon fiber concentration of 10 to 25 mass % and a length of 4 to 50 mm, and

(b) when the propylene-based resin-adhered carbon fiber bundle has 5000 to 16000 carbon fibers, it has an outer diameter of 2.8 mm or more and less than 3.3 mm, a carbon fiber concentration of 5 to 20 mass % and a length of 4 to 50 mm, and

a manufacturing method thereof.

The propylene-based resin-adhered carbon fiber bundle of the present invention can be manufactured by a manufacturing method, including the steps of:

adhering a propylene-based resin to a carbon fiber roving by feeding the propylene-based resin in a molten state from an extruder to a crosshead die while continuously pulling the carbon fiber roving through the crosshead die;

extruding the propylene-based resin-adhered carbon fiber roving in a strand shape from the crosshead die before cooling through a water bath in a room temperature atmosphere; and

thereafter, cutting the strand into a length of 5 to 40 mm,

wherein the strand has a surface temperature of 30° C. to 100° C. during the cutting step.

Further, the present invention provides a molded article composed of the propylene-based resin-adhered carbon fiber bundle.

A molded article obtained from the propylene-based resin-adhered carbon fiber bundle of the present invention has a high mechanical strength.

### DETAILED DESCRIPTION OF THE INVENTION

### <Propylene-Based Resin-Adhered Carbon Fiber Bundle>

The propylene-based resin used for the propylene-based resin-adhered carbon fiber bundle of the present invention contains a base polymer, and an acid-group containing propylene-based resin and/or an amino group-containing propylene-based resin. The base polymer is preferably selected from a propylene homopolymer and a propylene copolymer. The propylene copolymer is preferably a copolymer of propylene and ethylene, and it may be a random copolymer or a block copolymer. The copolymer of propylene and ethylene is preferably a copolymer having 50 mol % or more of a propylene unit.

Regarding the acid group-containing propylene-based resin and the amino group-containing propylene-based resin, either one of them is preferably used alone, but they may be used in combination.

The acid group-containing propylene-based resin is publicly known as disclosed in JP-B 4354776, JP-B 5021066 and JP-A 2007-112041.

Usable are:

(i) those obtained by graft-polymerization of an unsaturated carboxylic acid or a derivative thereof to a propylene homopolymer or a propylene copolymer;

(ii) those obtained by copolymerization of an unsaturated carboxylic acid or a derivative thereof to a raw material monomer of a propylene homopolymer or a propylene copolymer; and

(iii) those obtained by further graft-polymerization of an unsaturated carboxylic acid or a derivative thereof to the product of (ii).

Examples of the unsaturated carboxylic acid include compounds with a polymerizable double bond, having a carboxyl group such as maleic acid, fumaric acid, itaconic acid, acrylic acid and methacylic acid, and as needed, a functional group such as a hydroxyl group, an amino group or an epoxy group incorporated thereinto.

Further, examples of the derivative of unsaturated carboxylic acid include acid anhydrides, esters, amides, imides and metal salts thereof; and examples thereof include maleic anhydride, itaconic anhydride, methyl acrylate, ethyl acrylate, butyl acrylate, glycidyl acrylate, methyl methacrylate, ethyl methacrylate, glycidyl methacrylate, maleic acid monoethyl ester, maleic acid diethyl ester, fumaric acid monomethyl ester, fumaric acid dimethyl ester, acrylamide, methacrylamide, maleic acid monoamide, maleic acid diamide, fumaric acid monoamide, maleimide, N-butyl maleimide, and sodium methacrylate.

Among the above, glycidyl ester of acrylic acid and methacrylic acid, and maleic anhydride are preferably used.

Preferred examples of the acid group-containing propylene-based resin include a copolymer of polyethylene/ethylene and a glycidyl methacrylate copolymer; a combination of a polyethylene/maleic anhydride graft ethylene butene-1 copolymer; and polypropylene/maleic anhydride graft polypropylene.

From the viewpoint of the impregnating ability or the adhesion property to carbon fiber bundles, the acid modification amount of the acid group-containing propylene-based resin is preferably 0.05 to 10 mass %, more preferably 0.07 to 5 mass % and further preferably 0.1 to 3 mass % in terms of maleic anhydride.

As the amino group-containing propylene-based resin, exemplified are a reactant of an acid-modified polypropylene resin and a compound having an amino group, a reactant of an epoxidized polypropylene resin and a compound having an amino group, and others. It is preferred that the reactant is, for example, a reactant of a maleic anhydride graft polypropylene-based resin and a compound having two or more amino groups, wherein the reactant has a primary amino group from the viewpoint of the interaction with the base polymer or the carbon fiber bundle. From the same viewpoint, the content (mol %) of the amino group is preferably 0.02 to 30 mol %, more preferably 0.05 to 5.0 mol %.

Regarding the content ratio of the base polymer and the acid group-containing propylene-based resin and/or the amino group-containing propylene-based resin in the propylene-based resin, from the viewpoint of making extrusion property of a resin in the form of a pellet, moldability and physical properties of a molded article better, the content of the base polymer is preferably 85 to 99 mass %, more preferably 90 to 97 mass %; and the content of the acid group-containing propylene-based resin and/or the amino group-containing propylene-based resin is the remainder when the total of propylene-based resin is taken as 100 mass %.

The carbon fiber used in the propylene-based resin-adhered carbon fiber bundle of the present invention is disclosed in JP-B 4354776, JP-B 5021066 and JP-A 2007-112041 and is publicly known; and it is a carbon fiber of polyacrylonitrile (PAN)-base, pitch-base, rayon-base or the like, which is surface-treated with a sizing agent, and preferably a PAN-based carbon fiber.

As the carbon fiber, a roving-shaped carbon fiber prepared by bundling many single yarns is commercially available; its thickness, number of yarns and length are not particularly limited, but the single yarn diameter is preferably 20 μm or less, more preferably 15 μm or less, and further preferably 10 μm or less. The carbon fiber preferably has a total fineness of 400 to 3000 texes, and the carbon fiber has a number of filaments of preferably 1000 to 100000, and more preferably 3000 to 50000.

A sizing agent for surface treatment of carbon fiber is disclosed in JP-B 4354776, JP-B 5021066 and JP-A 2007-112041 and is publicly known; and it has a functional group capable of reacting with an acid group of an acid group-containing propylene-based resin and an amino group of an amino group-containing propylene-based resin.

As the sizing agent, usable are a compound having a functional group selected from a carboxyl group, an amino group, a hydroxyl group and an epoxy group, and two or more compounds described above may be used in combination. The compound to be used as the sizing agent may be a compound having a plurality of the same functional groups in one molecule, or may be a compound having a plurality of different functional groups in one molecule. The compound to be used as the sizing agent is preferably a compound having two or more functional groups in one molecule, more preferably a compound having three or more functional groups in one molecule. The compound to be used as the sizing agent may be an epoxy compound, an acrylic acid-based polymer, a polyhydric alcohol-based compound, a polyethyleneimine or the like.

As the sizing agent, usable are aliphatic compounds having a plurality of epoxy groups, and examples thereof include a diglycidyl ether compound and a polyglycidyl ether compound. The diglycidyl ether compound may be ethylene glycol diglycidyl ether and polyethylene glycol diglycidyl ethers, propylene glycol diglycidyl ether and polypropylene glycol diglycidyl ethers, 1,4-butanediol diglycidyl ether, neopentyl glycol diglycidyl ether, polytetramethylene glycol diglycidyl ether, polyalkylene glycol diglycidyl ethers, or the like. The polyglycidyl ether compound may be glycerol polyglycidyl ether, diglycerol polyglycidyl ether, polyglycerol polyglycidyl ethers, sorbitol polyglycidyl ethers, arabitol polyglycidyl ethers, trimethylol-propane polyglycidyl ethers, pentaerythritol polyglycidyl ethers, polyglycidyl ethers of aliphatic polyhydric alcohol, or the like.

Preferably, the sizing agent is an aliphatic polyglycidyl ether compound having a highly reactive glycidyl group, more preferably polyethylene glycol diglycidyl ethers, polypropylene glycol diglycidyl ethers, alkanediol diglycidyl ethers, or the like.

The amount of sizing agent to be used for a carbon fiber bundle is not particularly limited, but, from the viewpoint of the reactivity with an acid group of the acid group-containing propylene-based resin or an amino group of the amino group-containing propylene-based resin, the sizing agent is adhered uniformly in an amount of, for example, 0.01 to 10 mass %, preferably 0.05 to 5 mass %, and more preferably 0.1 to 2 mass %.

Examples of these carbon fibers surface-treated with a sizing agent include Torayca (registered trademark, manufactured by Toray Industries, Inc.) such as Torayca T700SC-24000-50C, which is a commercially available product.

The propylene-based resin-adhered carbon fiber bundle of the present invention is prepared by cutting into a predetermined length a carbon fiber bundle integrated with a propylene-based resin adhered thereto. The propylene-based resin-adhered carbon fiber bundle of the present invention may be divided into the following three forms in accordance with the adhering state of a propylene-based resin.

(I) one in a state where the resin is infiltrated (is impregnated) into the central part of a reinforcing long fiber bundle and the resin enters between fibers at the central part forming the fiber bundle (hereinafter, referred to “propylene-based resin impregnated fiber bundle”)
(II) one in a state where only the surface of the reinforcing long fiber bundle is coated with the resin (hereinafter, referred to “propylene-based resin surface-coated fiber bundle”)
(III) one in an intermediate state between the above states (the surface of the fiber bundle is coated with the resin, and the resin is impregnated only in the vicinity of the surface and does not enter into the central part) (hereinafter, referred to as “propylene-based resin partially impregnated fiber bundle)

In the present invention, a propylene-based resin impregnated fiber bundle and a propylene-based resin surface-coated fiber bundle are preferred, and a propylene-based resin impregnated fiber bundle is more preferred.

Resin-adhered fiber bundles in the forms of (I) to (III) are described in JP-A 2013-107979 (please note that a propylene-based resin is not used in the publication).

The propylene-based resin-adhered carbon fiber bundle of the present invention satisfies an outer diameter of 2.8 to 4.2 mm, a carbon fiber concentration of 5 to 25 mass % and a length of 4 to 50 mm.

The propylene-based resin-adhered carbon fiber bundle of the present invention may have a different diameter depending on the number of carbon fibers in the carbon fiber bundle.

(a) When the number of carbon fibers is 20000 to 28000, the outer diameter is 3.3 to 4.2 mm, the carbon fiber concentration is 10 to 25 mass %, and the length is 4 to 50 mm.
(b) When the number of carbon fibers is 5000 to 16000, the outer diameter is 2.8 mm or more and less than 3.3 mm, the carbon fiber concentration is 5 to 20 mass %, and the length is 4 to 50 mm.

### <Method for Manufacturing a Propylene-Based Resin-Adhered Carbon Fiber Bundle>

A method for manufacturing a propylene-based resin-adhered carbon fiber bundle of the present invention includes steps of:

adhering a propylene-based resin to a carbon fiber roving (carbon fiber bundle);

shaping as needed, extruding into a strand shape, and then cooling; and+

cutting into a predetermined length.

The step of adhering a propylene-based resin to a carbon fiber roving (carbon fiber bundle) can be carried out by applying the method described in Examples of JP-A 2013-107979; and in addition, it may be carried out in the same manner as the manufacturing methods described in JP-B 4354776, JP-B 5021066 and JP-A 2007-112041.

For example, the adhering step is carried out by adding an additive as needed, feeding a molten propylene-based resin from an extruder to a crosshead die while pulling the carbon fiber roving continuously through the crosshead die, and adhering the propylene-based resin to the carbon fiber roving.

In the cooling step, the resin-adhered fiber bundle is extruded in a strand shape from a shaping die connected to the crosshead die before cooling through a water bath in a room temperature (20 to 30° C.) atmosphere. The cooling step is performed so that the surface temperature of the strand is adjusted in the range of 30 to 100° C., preferably in the range of 40 to 90° C., at the time of cutting in the subsequent cutting step.

As a cooling method, applicable is a method for passing the strand (the extruded strand) in a water bath where the water temperature is kept lower than the room temperature, for example, 5 to 15° C. Further, the cooling time period (the time period for passing through the water bath) can be adjusted by controlling the length of the water bath, and for example, a plurality of water baths with a length of 100 to 300 mm may be combined, so that the cooling time period can be controlled by increasing or decreasing the number of the water baths.

After the cooling step, the strand is cut into a length of 4 to 50 mm, and the surface temperature of the strand at the time of cutting is 30 to 100° C. as described above. The cooling step and the cutting step are both carried out in a room temperature atmosphere (20 to 30° C.), so the surface temperature of the carbon fiber bundle is substantially in the range of 30 to 100° C. just after the cutting.

At the stage when the resin-adhered fiber bundle is extruded in a strand shape from the crosshead die, it still remains in a high temperature state. Thus, a reaction proceeds between a functional group such as an epoxy group of the sizing agent for surface-treating the carbon fiber bundle; and an acid group of the acid group-containing propylene-based resin or an amino group of the amino group-containing propylene-based resin, but cooling at the cooling step stops the reaction. In terms of obtaining a molded article with a high mechanical strength by sufficient progress of the reaction of the epoxy group with the acid or amino group, a method for ensuring a longer time period of the reaction by cooling under a softened condition such as natural cooling or passing-through in warm water may be considered. However, such a softened cooling method would cause drawbacks such as elongation of a manufacturing line from the cooling step to the cutting step and an increase in the total manufacturing period, and thereby, the productivity would be decreased.

However, the manufacturing method of the present invention satisfies two requirements:

(i) the surface temperature of the strand at the time of cutting in the cutting step is adjusted in the range of 30 to 100° C. (preferably in the range of 40 to 90° C.); and
(ii) the final propylene-based resin-adhered carbon fiber bundle with a larger diameter is less likely to get cold in comparison with those having a smaller diameter.
Thus, the method allows ensuring a longer reaction time period between functional groups such as an epoxy group present on the surface of the carbon fibers; and acid groups or amino groups contained in the propylene-based resin, and further, does not cause a decrease in the productivity.

As a result, the carbon fiber bundle and the propylene-based resin are more firmly bonded to each other, thereby enhancing the mechanical strength of a molded article without setting a particular thermal condition or conducting a particular thermal processing in the manufacturing step.

The width-directional cross sectional shape of the propylene-based resin-adhered carbon fiber bundle is preferably circular, but it may be oval or polygonal. When the width-directional cross sectional shape is oval or polygonal, a diameter of a circle having the same area as the shape is used as the diameter (outer diameter) thereof.

### <Molded Article>

A molded article of the present invention is obtained by molding into a desired shape by use of a propylene-based resin-adhered carbon fiber bundle of the present invention and by applying a publicly-known resin molding method such as injection molding and extrusion molding. The propylene-based resin contained in the molded article of the present invention consists only of the propylene-based resin contained in the propylene-based resin-adhered fiber bundle. That is, manufacturing the molded article of the present invention uses no diluent resin for adjusting a concentration of carbon fiber contained in the propylene-based resin-adhered fiber bundle.

The molded article of the present invention may contain a publicly-known resin additive as needed within such a range that can resolve the problem to be solved by the present invention. Examples of the publicly-known resin additive include an antioxidant, a heat resistant stabilizer, a stabilizer such as an ultraviolet absorbent, an antistatic agent, a flame retardant, a flame retardation assistant, a colorant such as a dye and a pigment, a lubricant, a plasticizer, a crystallization promoter, and a crystal nucleating agent. In addition, plate-like or powdery inorganic compounds of glass flakes, mica, glass powder, glass beads, talc, clay, alumina, carbon black, wollastonite or the like; whiskers; or the like may be added.

Hereinafter, various embodiments of the present invention are exemplified.

<1>

A propylene-based resin-adhered carbon fiber bundle prepared by cutting a carbon fiber bundle integrated with a propylene-based resin adhered thereto, wherein:

the propylene-based resin contains a base polymer selected from a propylene homopolymer and a propylene copolymer, and an acid group-containing propylene-based resin and/or an amino group-containing propylene-based resin;

the carbon fiber bundle has a sizing agent adhered on a surface thereof; and

the carbon fiber bundle has an outer diameter of 2.8 to 4.2 mm, a carbon fiber concentration of 5 to 25 mass % and a length of 4 to 50 mm.

<2>

The propylene-based resin-adhered carbon fiber bundle described in <1>, wherein when the total of the propylene-based resin is taken as 100 mass %, the base polymer is present in an amount of 85 to 99 mass %, preferably 90 to 98 mass %, and more preferably 93 to 97 mass %; and the acid group-containing propylene-based resin and/or the amino group-containing propylene-based resin are present in an amount of the remainder ratio.

<3>

The propylene-based resin-adhered carbon fiber bundle described in <1> or <2>, wherein a carbon fiber concentration is 10 to 20 mass %.

<4>

A propylene-based resin-adhered carbon fiber bundle prepared by cutting a carbon fiber bundle integrated with a propylene-based resin adhered thereto, wherein:

the propylene-based resin contains a base polymer selected from a propylene homopolymer and a propylene copolymer, and an acid group-containing propylene-based resin and/or an amino group-containing propylene-based resin;

the carbon fiber bundle has a sizing agent adhered on a surface thereof; and

(a) when the carbon fiber bundle has a number of carbon fibers of 20000 to 28000, it has an outer diameter of 3.3 to 4.2 mm, a carbon fiber concentration of 10 to 25 mass %, and a length of 4 to 50 mm, and

(b) when the carbon fiber bundle has a number of carbon fibers of 5000 to 16000, it has an outer diameter of 2.8 mm or more and less than 3.3 mm, a carbon fiber concentration of 5 to 20 mass %, and a length of 4 to 50 mm.

<5>

The propylene-based resin-adhered carbon fiber bundle described in <4>, wherein

(a) when the carbon fiber bundle has a number of carbon fibers of 20000 to 28000, it has an outer diameter of 3.5 to 4.0 mm, a carbon fiber concentration of 15 to 20 mass %, and a length of 4 to 50 mm, and

(b) when the carbon fiber bundle has a number of carbon fibers of 5000 to 16000, it has an outer diameter of 2.8 to 2.9 mm, a carbon fiber concentration of 10 to 17 mass %, preferably 15 to 17 mass %, and a length of 4 to 50 mm.

<6>

The propylene-based resin-adhered carbon fiber bundle described in <4> or <5>, wherein when the total of the propylene-based resin is taken as 100 mass %, the base polymer is present in an amount of 85 to 99 mass %, preferably 90 to 98 mass %, and more preferably 93 to 97 mass %; and the acid group-containing propylene-based resin and/or the amino group-containing propylene-based resin are present in an amount of the remainder ratio.

<7>

The propylene-based resin-adhered carbon fiber bundle described in any of <1> to <6>, wherein the acid group-containing propylene-based resin is a maleic acid or maleic anhydride-modified propylene homopolymer or propylene copolymer, and the sizing agent contains an epoxy group.

<8>

The propylene-based resin-adhered carbon fiber bundle described in any of <1> to <7>, wherein the amino group-containing propylene-based resin is a reactant of an acid-modified polypropylene resin and a compound having an amino group or a reactant of an epoxidized polypropylene resin and a compound having an amino group.

<9>

A method for manufacturing the propylene-based resin-adhered carbon fiber bundle described in any of <1> to <8>, including the steps of:

adhering a propylene-based resin to a carbon fiber roving by feeding the propylene-based resin in a molten state from an extruder to a crosshead die while continuously pulling the carbon fiber roving through the crosshead die;

extruding the propylene-based resin-adhered carbon fiber roving in a strand shape from the crosshead die before cooling through a water bath in a room temperature atmosphere; and

thereafter, cutting the strand into a length of 5 to 40 mm,

wherein the strand has a surface temperature of 30 to 100° C. during the cutting step.

<10>

The manufacturing method of <9>, wherein the water bath has a water temperature kept lower than a room temperature, preferably at 5 to 15° C.

<11>

The manufacturing method of <9> or <10>, wherein the water bath has a length of 100 to 300 m and/or a plurality of water baths are combined for use.

<12>

The manufacturing method described any of <9> to <11>, wherein the cutting step is carried out in a room temperature atmosphere, and the carbon fiber bundle immediately after the cutting has a surface temperature of 30 to 100° C.

<13>

A molded article prepared by molding in a predetermined shape by use of the propylene-based resin-adhered carbon fiber bundle described in any of <1> to <8>,

wherein a propylene resin component in the molded article consists only of a propylene-based resin contained in the propylene-based resin-adhered carbon fiber bundle.

### EXAMPLES

### Examples 1 to 11 and Comparative Example 1 to 10

While a carbon fiber roving treated with a sizing agent is being pulled, a propylene-based resin having a base polymer and an acid group/amino group-containing polypropylene resin blended with each other at a ratio shown in Table 1 or 2 was fed from an extruder connected to a crosshead, so that the carbon fiber roving was impregnated with the resin in a molten state (260° C.) and then, pulled out through a shaping die as a strand. Thereafter, the strand was cooled through a water bath at room temperature (20 to 30° C.). Then, the strand was cut, so that a propylene-based resin-adhered carbon fiber bundle having a length shown in Table 1 or 2 was obtained.

In the cooling step, 3 to 10 water baths (water temperature: 10° C.) with a length of 180 mm were used in series arrangement; and the number of them was appropriately increased or decreased so that the surface temperature of each fiber bundle at the time of cutting was adjusted to those shown in Table 1 or 2. The surface temperature of fiber bundle was measured by a non-contact radiation thermometer (IT-550 manufactured by Horiba, Ltd.).

The fiber bundle of each example was injection-molded under the following conditions, and a molded article was obtained. However, the carbon fiber bundles of Comparative Example 2 and 3 were mixed with a diluent resin, so that their carbon fiber concentrations were adjusted.

### (Injection Molding)

Device: J150EII (manufactured by The Japan Steel Works, LTD.)
Molding temperature (setting temperature of a cylinder: 250° C.)
Die temperature (setting temperature of a temperature controller: 50° C.)
Molded article: ISO multi-purpose test specimen

### (Physical Property Measurements of a Molded Article)

The ISO multi-purpose test specimen prepared under the above molding conditions was used for the following measurements. Results are shown in Table 1.

Tensile strength: measured in accordance with ISO 527-1
Bending strength: measured in accordance with ISO 178

### (Resin and Carbon Fiber)

PP-A: base polymer: Sun-Allomer PMB60A (propylene ethylene copolymer)
Carbon fiber (CF-A): Torayca T700SC-24000-50C (number of carbon fibers: 24000)
Carbon fiber (CF-B): Torayca T700SC-12000-50C (number of carbon fibers: 12000)
Carbon fiber (CF-C): obtained by dividing the carbon fiber (CF-B) into two pieces (number of carbon fibers: 6000)
Acid group-containing polypropylene-based resin: maleic anhydride-modified polypropylene: OREVAC CA100 (manufactured by Arkema K.K., modified with 1.0 mass % of maleic anhydride)

### Production Example 1 (Production of Amino Group-Containing Polypropylene)

100 parts by mass of maleic anhydride-modified polypropylene (OREVAC CA100 manufactured by Arkema K.K., modified with 1.0 mass % maleic anhydride) was blended with 100 parts by mass of polypropylene homopolymer (MFR 120 g/10 min, Sumitomo Noblen U501EI manufactured by Sumitomo Chemical Co., Ltd.) and 10 parts by mass of JEFFAMINE D-230 (aliphatic primary diamine induced by polypropylene glycol, manufactured by HUNTSMAN), and the mixture was fed to a biaxial extruder (setting temperature: 200° C., screw rotation number: 200 r/m, TEX30aα, manufactured by The Japan Steel Works, LTD.) and molten and mixed, so that amino group-containing polypropylene was obtained.

An infrared absorption spectrum was used to confirm that the obtained one was amino group-containing polypropylene. As a result, it was confirmed that absorption peaks for maleic anhydride and maleic acid at 1680 to 1820 cm⁻¹ disappeared and an absorption peak at 1500 to 1700 cm⁻¹ that is considered to be derived from an amino group appeared.

TABLE 1

| | | | | | | | | | | Comparative | |
|---|---|---|---|---|---|---|---|---|---|---|---|
| Examples | | | | | Comparative Examples | | | Examples | | Examples | |
| 1 | 2 | 3 | 4 | 5 | 1 | 2 | 3 | 6 | 7 | 4 | 5 |

| | | | | | | | | | | | | | |
|---|---|---|---|---|---|---|---|---|---|---|---|---|---|
| Resin-adhered | Amount of PP-A (mass %) | 95 | 95 | 96.2 | 96.2 | 96.2 | 92.5 | 95 | 96.2 | 96.2 | 95.7 | 95 | 95 |
| fiber bundle | Amount of acid group- | 5 | 5 | 3.8 | 3.8 | 3.8 | 7.5 | 5 | 3.8 | 3.8 | 4.3 | 5 | 5 |
| | containing PP (mass %) | | | | | | | | | | | | |
| | Carbon fiber bundle | CF-A | CF-A | CF-A | CF-A | CF-A | CF-A | CF-A | CF-A | | | | |
| | CF-A (24000) | | | | | | | | | | | | |
| | Carbon fiber bundle | | | | | | | | | CF-B | CF-B | CF-B | CF-B |
| | CF-B (12000) | | | | | | | | | | | | |
| | Carbon fiber conc. (mass %) | 20 | 20 | 15 | 15 | 15 | 30 | 40 | 40 | 15 | 17 | 20 | 20 |
| | Fiber bundle diameter (mm) | 3.5 | 3.5 | 4.0 | 4.0 | 4.0 | 2.7 | 2.3 | 2.3 | 2.9 | 2.8 | 2.5 | 2.5 |
| | Fiber bundle length (mm) | 6 | 11 | 11 | 11 | 11 | 11 | 11 | 11 | 11 | 11 | 11 | 11 |
| | Surface temp. at the | 50 | 50 | 30 | 60 | 90 | 50 | 60 | 60 | 70 | 60 | 20 | 50 |
| | time of cutting (° C.) | | | | | | | | | | | | |

| | | | | | | | | | | | | |
|---|---|---|---|---|---|---|---|---|---|---|---|---|
| Diluent resin (PP-A) | None | None | None | None | None | None | Used | Used | None | None | None | None |
| Fiber concentration (%) | 20 | 20 | 15 | 15 | 15 | 30 | 20 | 15 | 15 | 17 | 20 | 20 |
| Tensile strength (MPa) | 150 | 155 | 130 | 140 | 145 | 145 | 125 | 120 | 135 | 145 | 100 | 110 |
| Bending strength (MPa) | 195 | 200 | 180 | 185 | 190 | 220 | 175 | 170 | 180 | 190 | 150 | 160 |

As is obvious from a comparison between Examples 1 and 2 (carbon fiber concentration: 20 mass %, fiber bundle diameter: 3.5 mm, temperature at the time of cutting: 50° C.) and Comparative Example 1 (carbon fiber concentration: 30 mass %, fiber bundle diameter: 2.7 mm, temperature at the time of cutting: 50° C.), Examples 1 and 2 had a higher tensile strength because they had a larger fiber bundle diameter and were less likely to get cold in spite of the fact that the carbon fiber concentration was lower by 10 mass %.

As is obvious from a comparison between Example 4 (carbon fiber concentration 15 mass %, fiber bundle diameter: 4.0 mm, temperature at the time of cutting: 60° C.) and Comparative Example 3 (carbon fiber concentration 15 mass %, fiber bundle diameter: 2.3 mm, temperature at the time of cutting: 60° C.), both of the tensile strength and the bending strength of Example 4 were higher because Example 4 had a larger fiber bundle diameter and was less likely to get cold.

As is obvious from a comparison on Examples 3 to 5, a higher surface temperature of a fiber bundle at the time of cutting provided better tensile strength and bending strength if other requirements are the same.

As is obvious from a comparison between Examples 6 and 7 and Comparative Examples 4 and 5, the tensile strength and the bending strength were increased by controlling two requirements: the diameter of fiber bundle and the surface temperature of fiber bundle at the time of cutting.

TABLE 2

| | | | | | | | | | Comparative | |
|---|---|---|---|---|---|---|---|---|---|---|
| | | Examples | | Comparative Examples | | | Examples | | Examples | |
| | | 8 | 9 | 6 | 7 | 8 | 10 | 11 | 9 | 10 |
| Resin-adhered | Amount of PP-B (mass %) | 95 | 93 | 95 | 96.2 | 93 | 96.2 | 97.5 | 95 | 93 |
| fiber bundle | Amount of acid group-containing | 5 | | 5 | 3.8 | | 3.8 | 2.5 | 5 | |
| | PP (mass %) | | | | | | | | | |
| | Amino group-containing PP amount | | 7 | | | 7 | | | | 7 |
| | (mass %) | | | | | | | | | |
| | Carbon fiber bundle CF-A (24000) | CF-A | CF-A | CF-A | CF-A | CF-A | | | | |
| | Carbon fiber bundle CF-B (12000) | | | | | | CF-B | | CF-B | CF-B |
| | Carbon fiber bundle CF-C (6000) | | | | | | | CF-C | | |
| | Carbon fiber conc. (mass %) | 20 | 20 | 40 | 40 | 40 | 15 | 10 | 20 | 20 |
| | Fiber bundle diameter (mm) | 3.5 | 3.5 | 2.3 | 2.3 | 2.3 | 2.9 | 2.8 | 2.5 | 2.5 |
| | Fiber bundle length (mm) | 8 | 11 | 11 | 11 | 11 | 11 | 11 | 11 | 11 |
| | Surface temp. at the timd | 45 | 70 | 50 | 50 | 50 | 60 | 50 | 50 | 20 |
| | of cutting (° C.) | | | | | | | | | |

| | | | | | | | | | |
|---|---|---|---|---|---|---|---|---|---|
| Diluent resin (PP-B) | None | None | Used | Used | Used | None | None | None | None |
| Fiber concentration (%) | 20 | 20 | 20 | 15 | 20 | 15 | 10 | 20 | 20 |
| Tensile strength (MPa) | 190 | 180 | 150 | 140 | 140 | 180 | 165 | 150 | 140 |
| Bending strength (MPa) | 235 | 220 | 190 | 170 | 180 | 220 | 190 | 190 | 190 |

As is obvious from a comparison between Examples 8 and 9 and Comparative Examples 6 to 8, the tensile strength and the bending strength were increased by adjusting two requirements: the diameter of fiber bundle and the surface temperature of fiber bundle at the time of cutting.

As is obvious from a comparison between Examples 10 and 11 and Comparative Examples 9 and 10, the tensile strength and the bending strength were increased by controlling two requirements: the diameter of fiber bundle and the surface temperature of fiber bundle at the time of cutting.

### INDUSTRIAL APPLICABILITY

Molded articles obtained from the propylene-based resin-adhered carbon fiber bundle of the present invention are lightweight and exhibit a high mechanical strength, and thus, they can be used for housings for various products, containers, parts of electronic/electric appliances, automobile parts, and others.

1. A propylene-based resin-adhered carbon fiber bundle prepared by cutting a carbon fiber bundle integrated with a propylene-based resin adhered thereto, wherein:
the propylene-based resin comprises a base polymer selected from a propylene homopolymer and a propylene copolymer, and an acid group-containing propylene-based resin and/or an amino group-containing propylene-based resin;
the carbon fiber bundle has a sizing agent adhered on a surface thereof; and
the carbon fiber bundle has an outer diameter of 2.8 to 4.2 mm, a carbon fiber concentration of 5 to 25 mass % and a length of 4 to 50 mm.

2. A propylene-based resin-adhered carbon fiber bundle prepared by cutting a carbon fiber bundle integrated with a propylene-based resin adhered thereto, wherein:
the propylene-based resin contains a base polymer selected from a propylene homopolymer and a propylene copolymer, and an acid group-containing propylene-based resin and/or an amino group-containing propylene-based resin;
the carbon fiber bundle has a sizing agent adhered on a surface thereof; and
(a) when the carbon fiber bundle has a number of carbon fibers of 20000 to 28000, it has an outer diameter of 3.3 to 4.2 mm, a carbon fiber concentration of 10 to 25 mass %, and a length of 4 to 50 mm, and
(b) when the carbon fiber bundle has a number of carbon fibers of 5000 to 16000, it has an outer diameter of 2.8 mm or more and less than 3.3 mm, a carbon fiber concentration of 5 to 20 mass %, and a length of 4 to 50 mm.

3. The propylene-based resin-adhered carbon fiber bundle according to claim 1, wherein the acid group-containing propylene-based resin is a maleic acid or maleic anhydride-modified propylene homopolymer or propylene copolymer, and the sizing agent contains an epoxy group.

4. A method for manufacturing the propylene-based resin-adhered carbon fiber bundle according to claim 1, the method comprising the steps of:
adhering a propylene-based resin to a carbon fiber roving by feeding the propylene-based resin in a molten state from an extruder to a crosshead die while continuously pulling the carbon fiber roving through the crosshead die, and;
extruding the propylene-based resin-adhered carbon fiber roving in a strand shape from the crosshead die before cooling through a water bath in a room temperature atmosphere; and
thereafter, cutting the strand into a length of 5 to 40 mm,
wherein the strand has a surface temperature of 30 to 100° C. during the cutting step.

5. A molded article made of the propylene-based resin-adhered carbon fiber bundle according to claim 1,
wherein a propylene resin component in the molded article consists only of a propylene-based resin contained in the propylene-based resin-adhered carbon fiber bundle.
